(19) United States
(12) Patent Application Publication
(10) Pub. No.: US 2007/0152918 A1
(43) Pub. Date: Jul. 5, 2007

(54) PLASMA DISPLAY APPARATUS

(75) Inventor: Bong Sup JUNG, Busan-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/279,688

(22) Filed: Apr. 13, 2006

(30) Foreign Application Priority Data
Jan. 5, 2006 (KR) 10-2006-0001445

(51) Int. Cl. G09G 3/28

(52) U.S. Cl. 345/68

(57) ABSTRACT

Provided a plasma display apparatus. The apparatus includes a first electrode and a driver. The first electrode is formed at an upper substrate. The driver applies a sustain pulse to the first electrode. The driver applies a driving waveform whose, in one subfield, any one sustain pulse (SP1) has a longer falling time than another sustain pulse (SP2) applied earlier than the sustain pulse (SP1).

### BACKGROUND OF THE INVENTION

1. Field of the Invention

The present invention relates to a plasma display apparatus, and more particularly, to a plasma display apparatus for lengthening a falling time of a sustain pulse applied in the last of a sustain period and partially erasing wall charges excessively formed within a discharge cell, thereby preventing erroneous discharge.

2. Description of the Background Art

FIG. 1 illustrates a driving waveform for driving a conventional plasma display apparatus, and FIG. 2 illustrates a sustain pulse applied in the last of a sustain period in the conventional plasma display apparatus.

As shown in FIG. 1, the driving waveform is comprised of a reset period (R), an address period (A), and a sustain period (S). During the reset period, a setup reset signal (R-up) and a setdown reset signal (R-dn) are sequentially supplied. If the setup reset signal (R-up) is supplied, reset discharge is generated between a scan electrode (Y) and a sustain electrode (Z) while wall charges are stored in a dielectric layer on the scan electrode (Y) and the sustain electrode (Z). If the setdown reset signal (R-dn) is supplied, wall charges are erased from a discharge cell, thereby securing operation margin of a driving circuit.

During the address period (A), depending on, image data, a positive (+) data pulse is applied to an address electrode (X), and a negative (−) scan pulse opposite to the data pulse is supplied to the scan electrode (Y). In the case of a cell to which the data pulse is applied, address discharge is generated by a voltage difference between the data pulse and the scan pulse.

During the sustain period (S), the sustain pulse is alternately supplied to the scan electrode (Y) and the sustain electrode (Z). If the sustain pulse is supplied to the cell in which the address discharge is generated, sustain discharge is generated and an image is displayed.

In one subfield, after finishing of main sustain discharge, the sustain pulse (SP) applied in the last of the sustain period (S) serves to from a wall charge distribution for reset discharge or erasure discharge of a next subfield through strong discharge.

As shown in FIG. 2, for the above serving, a last sustain pulse (SP) is constructed to have a short rising time (Tr) and a falling time (Tf) longer than the rising time.

When the last sustain pulse (SP) is applied, the falling time (Tf) of the sustain pulse gets longer. This is to, during the falling time, erase the wall charges excessively, formed within the discharge cell.

For example, in the last sustain pulse, the rising time (Tr) is set to 480 ns, and the falling time (Tf) is set to 600 ns.

However, there is a drawback in that, even though the falling time (Tf) of the last sustain pulse is set to about 600 ns, when the last sustain pulse (SP) is applied, the excessively formed wall charges are not sufficiently erased from the discharge cell and erroneous discharge of luminescent spot is generated.

### SUMMARY OF TILE INVENTION

Accordingly, an object of the present invention is to solve at least the problems and disadvantages of the background art.

An object of the present invention is to provide a plasma display apparatus for lengthening a falling time of a last sustain pulse applied to a scan electrode and a sustain electrode in the last of a sustain period, sufficiently erasing some of wall charges excessively formed within a discharge cell, and normally erasing the wall charges in erasure, thereby preventing erroneous discharge.

To achieve these and other advantages and in accordance with the purpose of the present invention, as embodied and broadly described, there is provided a plasma display apparatus including a first electrode and a driver. The first electrode is formed at an upper substrate. The driver applies a sustain pulse to the first electrode. The driver applies a driving waveform whose, in one subfield, any one sustain pulse (SP1) has a longer falling time than another sustain pulse (SP2) applied earlier than the sustain pulse (SP1).

In another aspect of the present invention, there is provided a plasma display apparatus including a first electrode and a driver. The first electrode is formed at an upper substrate. The driver applies a sustain pulse to the first electrode. The driver applies a driving waveform whose, in one subfield, any one sustain pulse (SP1) comprises duration for falling from high electric potential voltage to first voltage, duration for substantially sustaining the first voltage for a predetermined time, and duration for falling from the first voltage to low electric potential voltage, and its total falling time is longer than a falling time of another sustain pulse (SP2) applied earlier than the sustain pulse (SP1).

In a further another aspect of the present invention, there is provided a plasma display apparatus including a first electrode and a driver. The first electrode is formed at an upper substrate. The driver applies a sustain pulse to the first electrode. The driver applies a driving waveform whose, in one subfield, upon fall, any one sustain pulse (SP1) falls along slopes having at least two steps, and its total falling time is longer than a falling time of another sustain pulse (SP2) applied earlier than the sustain pulse (SP1).

### BRIEF DESCRIPTION OF THE DRAWINGS

The invention will be described in detail with reference to the following drawings in which like numerals refer to like elements.

FIG. 1 illustrates a driving waveform for driving a conventional plasma display apparatus;

FIG. 2 illustrates a sustain pulse applied in the last of a sustain period in a conventional plasma display apparatus;

FIG. 3 illustrates a driving waveform of a plasma display apparatus according to a first embodiment of the present invention;

FIG. 4 illustrates a driving waveform of a plasma display apparatus according to a second embodiment of the present invention;

FIG. 5 illustrates a driving waveform of a plasma display apparatus according to a third embodiment of the present invention;

FIG. 6 illustrates a sustain pulse application circuit of a plasma display apparatus according to the present invention; and

FIG. 7 is a timing diagram of a switch for applying a sustain pulse according to the present invention.

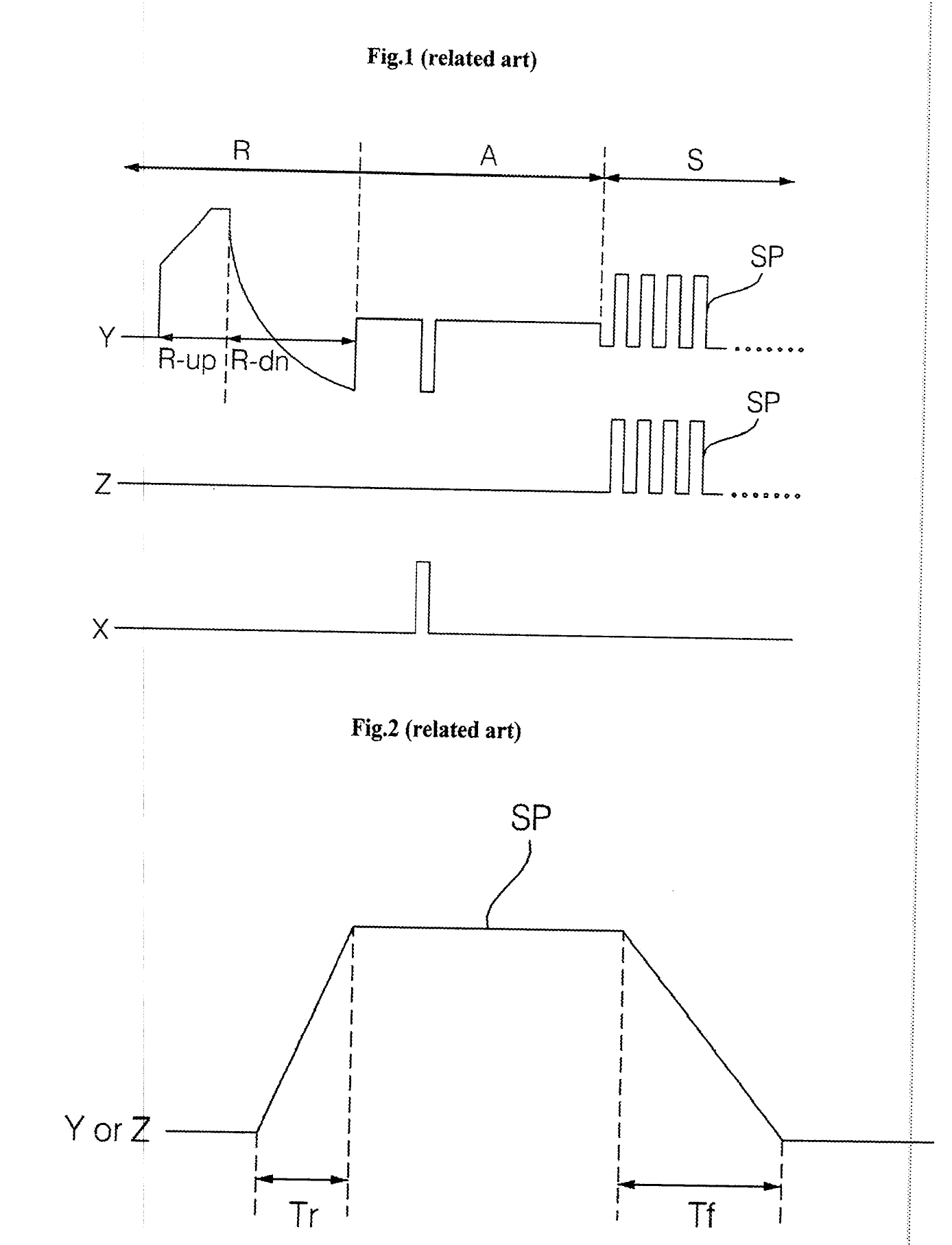

### DETAILED DESCRIPTION OF PREFERRED EMBODIMENTS

Preferred embodiments of the present invention will be described in a more detailed manner with reference to the drawings.

FIG. 3 illustrates a driving waveform of a plasma display apparatus according to a first embodiment of the present invention.

The inventive plasma display apparatus includes a first electrode at an upper substrate, and a driver for applying a driving signal to the first electrode. By the driving waveform applied by the driver, discharge is generated and an image is displayed.

The first electrode can be any one of a scan electrode and a sustain electrode. The driver refers to a scan electrode driver or a sustain electrode driver corresponding to the first electrode.

The plasma display apparatus is driven with one frame divided into a plurality of subfields. Each of the subfields includes a reset period for initializing discharge cells of a whole screen, an address period for selecting the discharge cell, a sustain period for sustaining discharge of the selected discharge cell, and an erasure period for erasing wall charges within the discharge cell.

During the reset period, the same high voltage is applied to the scan electrode (Y) in all discharge cells irrespective of On/Off of the discharge cell in an earlier subfield and accordingly, reset discharge is generated within the discharge cell.

During the address period, a scan pulse is sequentially applied to the scan electrode (Y), and a data pulse is synchronized with the scan pulse and is synchronously applied to an address electrode. In the discharge cell to which the scan pulse and the data pulse are applied, address discharge is generated.

In the sustain period, a sustain pulse is alternately applied to the scan electrode (Y) and the sustain electrode (Z). In the discharge cell where the address discharge is generated during the address period, sustain discharge is generated and gray level is expressed.

In the erasure period, an erasure ramp waveform is applied to the sustain electrode (Z), and a ground level voltage is applied to the scan electrode (Y). If the erasure ramp waveform is applied to the discharge cell where the sustain discharge is generated, erasure discharge is generated between the scan electrode (Y) and the sustain electrode (Z), and the wall charges formed within the discharge cell are erased.

A last sustain pulse (SP1) applied during the sustain period generates strong discharge before the erasure period, and erases the wall charges excessively formed within the discharge cell, thereby allowing stable erasure and reset discharges.

As shown in FIG. 3, the plasma display apparatus according to the first embodiment of the present invention includes the first electrode formed at the upper substrate, and the driver for applying the sustain pulse to the first electrode. The driver is characterized to, in one subfield, apply a driving waveform whose any one sustain pulse (SP1) has a longer falling time than another sustain pulse (SP2) applied earlier than the sustain pulse (SP1).

The first electrode is the scan electrode or the sustain electrode, and the sustain pulse (SP1) can be applied to all or any one of both electrodes.

In particular, in the last sustain pulse (SP1) applied during the sustain period, a fall time (Tf) taken to reduce from high electric potential sustain voltage (Vs) to low electric potential sustain voltage (Vo) is excessively long sustained to secure time for erasing the wall charges formed within the discharge cell, thereby leading self-erasing and reinforcing erasure discharge.

The low electric potential voltage is a reference voltage of the sustain pulse, and generally is a ground voltage.

The falling time (Tf) of the last sustain pulse (SP1) applied during the sustain period is set to be longer than a falling time (Tfp) of the sustain pulse (SP2) applied earlier than the last sustain pulse.

The falling time (Tfp) of the sustain pulse (SP2) applied earlier than the last sustain pulse (SP1) is set to be within a range of about 480 ns to 600 ns. The falling time (Tf) of the last sustain pulse should be set to be within a range of about 1 μs to 2 μs. For example, the falling time (Tf) of the last sustain pulse is set to be about 1.5 μs to 2 μs.

In particular, the sustain pulse (SP1) is applied to the last of the sustain period. The duration (Tr) for rising from the high electric potential sustain voltage (Vo) to the high electric potential sustain voltage (Vs) is set to be within a range of about 480 ns to 540 ns.

Next, a period for sustaining the high electric potential sustain voltage (Vs) can be differently set depending on the scan electrode (Y) and the sustain electrode (Z). In case where the sustain pulse is first applied to the scan electrode, a period for sustaining the high electric potential sustain voltage of the scan electrode can be set to be about 16 μs, and a period for sustaining the high electric potential sustain voltage of the sustain electrode can be set to be about 5 μs.

As described above, the sustain pulse (SP1) is applied for the last sustain pulse in one subfield, for example, but without limitation to this, a plurality of sustain pulses just earlier than the last sustain pulse can be constructed to have a format of the sustain pulse (SP1).

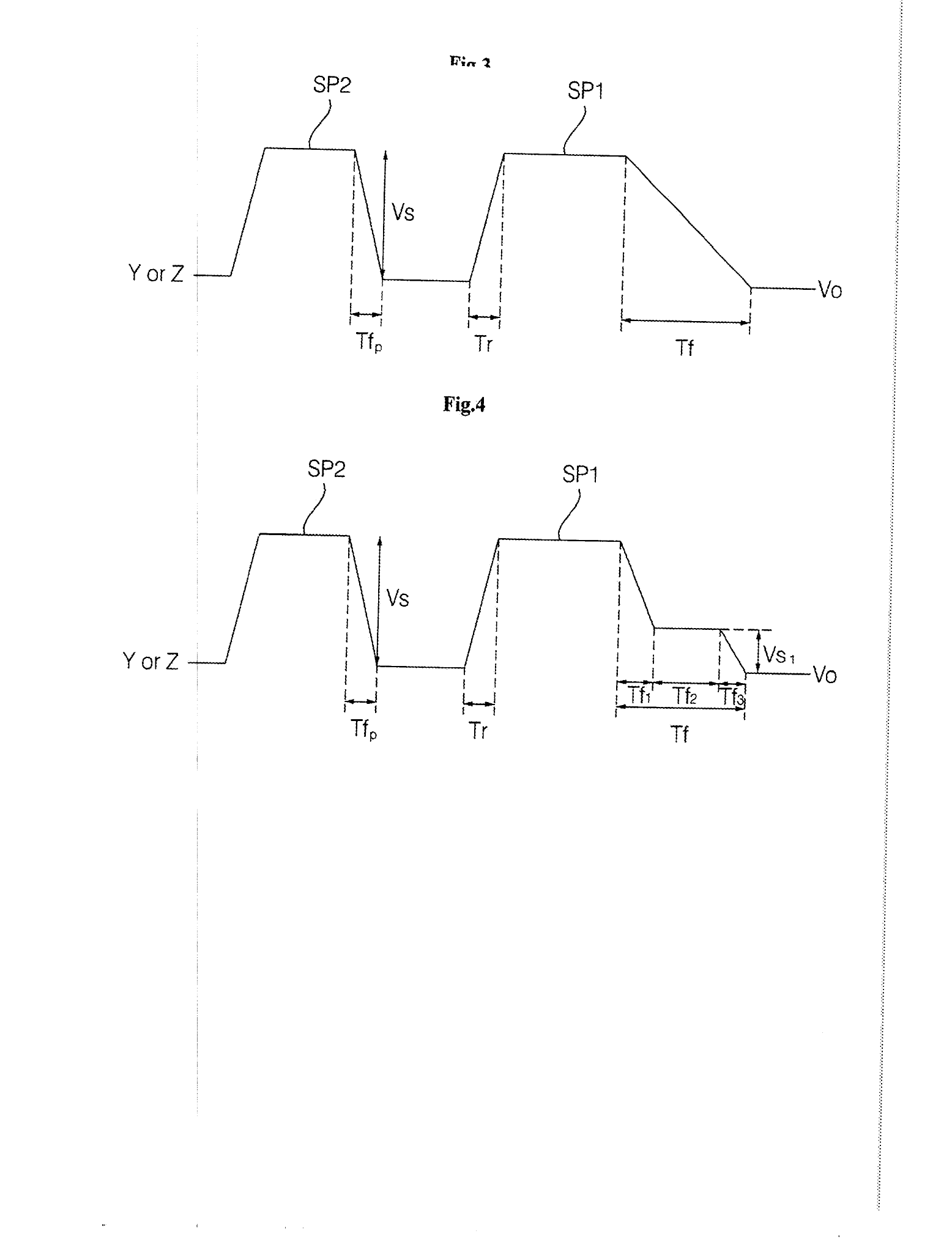

FIG. 4 illustrates a driving waveform of a plasma display apparatus according to a second embodiment of the present invention.

Referring to FIG. 4, the plasma display apparatus according to the second embodiment of the present invention has a waveform whose, in one subfield, any one sustain pulse (SP1) reduces from high electric potential voltage (Vs) to first sustain voltage (Vs₁), sustains the first sustain voltage for a predetermined time, and then reduces to low electric potential sustain voltage (Vo).

The above sustain pulse (SP1) is applied for the last sustain pulse in one subfield, for example, but without limitation to this, a plurality of sustain pulses just earlier than the last sustain pulse can be also constructed to have a format of the sustain pulse (SP1).

In the second embodiment of the present invention, a total falling time of the last sustain pulse is set to be longer than a failing time of any one sustain pulse (SP2) applied earlier than the last sustain pulse.

The first sustain voltage (Vs₁) is set to be within a range of about 30 V to 50 V. This is a voltage caused by electric conduction of a second recovery switch (ER-down) of an energy recovery unit (ER) described later.

In the sustain pulse (SP1), the total falling time (Tf) from the high electric potential voltage to the low electric potential voltage is within a range of about 1.5 μs to 2 μs.

In other words, a period (Tf) for reducing from the high electric potential sustain voltage (Vs) to the low electric potential voltage (Vo) is set to be within a range of about 1.5 μs to 2 μs. A period (Tf₁) for reducing from the high electric potential sustain voltage (Vs) to the first sustain voltage (Vs₁) can be different depending on circuit construction of the plasma display apparatus. A period (Tf2) for sustaining the first sustain voltage (Vs₁) should be set to be at least about 500 ns.

In detail, in the falling time (Tf) of the last sustain pulse (SP1), the first sustain voltage (Vs₁) should be sustained within a range of about 500 ns to 1 μs. For example, the first sustain voltage (Vs₁) is sustained during about 600 ns.

As described above, in the last sustain pulse (SP1), self-erasing is performed to erase wall charges excessively formed within the discharge cell during a period of sustaining the first sustain voltage (Vs₁).

As described above, the falling time (Tf) of the last sustain pulse (SP1) applied in the last of the sustain period is long sustained. Specifically, while the first sustain voltage (Vs1) is sustained for 500 ns, the self-erasing is generated, and normal erasure and reset discharges are performed during subsequently coming erasure and reset periods.

If the wall charges are excessively generated within the discharge cell, even though the erasure and reset discharges are performed, charge unbalance between the discharge cells is caused. This causes generation of erroneous discharge such as turn on of a cell that has to be in a turn off state, or generation of strong discharge in a specific discharge cell, thereby causing deterioration of a picture quality such as pop-up of a luminescent spot.

Accordingly, in order to prevent this, the falling time (Tf) of the last sustain pulse gets long and the erasure and reset discharges are stably performed as described above. If so, there is effect of reducing the generation of the erroneous discharge or flickering of the luminescent point of the plasma display apparatus, thereby improving the picture quality.

Other remaining constructions and operations are substantially the same as those of the first embodiment of the present invention.

FIG. 5 illustrates a driving waveform of a plasma display apparatus according to a third embodiment of the present invention.

Referring to FIG. 5, in the plasma display apparatus according to the third embodiment of the present invention, it is characterized to apply a driving waveform whose, in one subfield, upon fall, any one sustain pulse (SP1) falls along slopes having two or more steps, and its total falling time gets longer than a falling time of another sustain pulse (SP2) applied earlier than the sustain pulse (SP1).

The sustain pulse (SP1) is applied for the last sustain pulse as described above, for example, but without limitation to this, a plurality of sustain pulses just earlier than the last sustain pulse can be also constructed to have a format of the sustain pulse (SP1).

The first electrode is the scan electrode or the sustain electrode, and the sustain pulse (SP1) can be applied to all or any one of both electrodes.

Further, the slopes of the respective steps can be different from each other.

FIG. 5 illustrates an example of the waveform the sustain pulse (SP1) of which falls along slopes having three steps. The driver applies the driving waveform falling along the slopes having the three steps whose second step has a falling time of about 500 ns to 1 μs.

In the first step, the sustain pulse (SP1) falls along the first slope from high electric potential sustain voltage (Vs) to a first voltage (Vs₁). In the second step, the sustain pulse (SP1) falls along the second slope from the first voltage (V1) to a second voltage (Vs₂). In the third step, the sustain pulse (SP1) falls along the third slope from the second voltage (Vs₂) to the low electric potential voltage (Vo).

The slope of the second step, that is, the second slope is configured to be gentler than the remaining two slopes. By applying the waveform whose, in the second step, slope gets gentle and falling time is delayed while reduction is gradually made, the wall charges are effectively erased.

The falling time of the sustain pulse (SP2) applied earlier than the sustain pulse (SP1) is within a range of about 480 ns to 600 ns.

In the sustain pulse (SP1), the total falling time from the high electric potential sustain voltage (Vs) to the low electric potential sustain voltage (Vo) is set to be within a range of about 1.5 μs to 2 μs.

Other remaining constructions and operations are substantially the same as those of the first embodiment of the present invention.

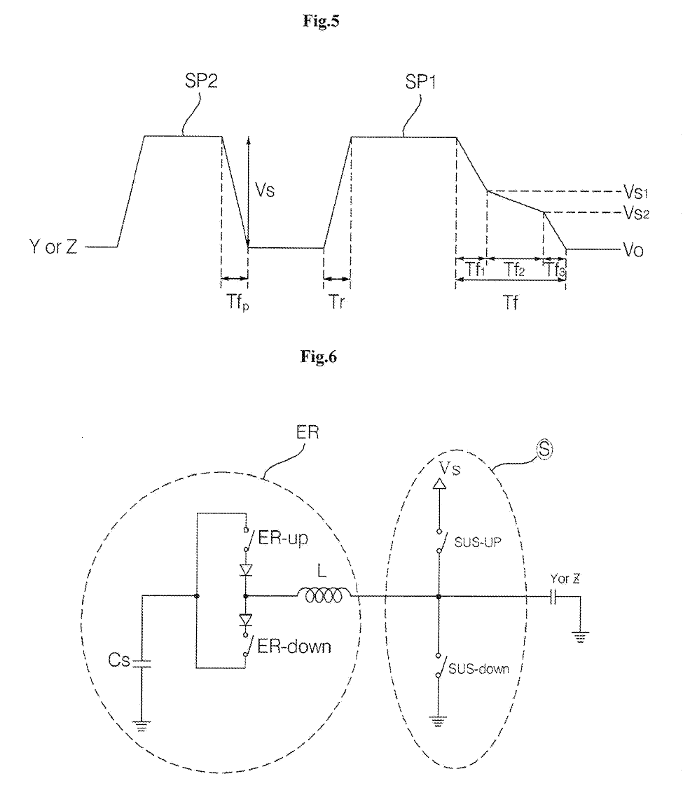

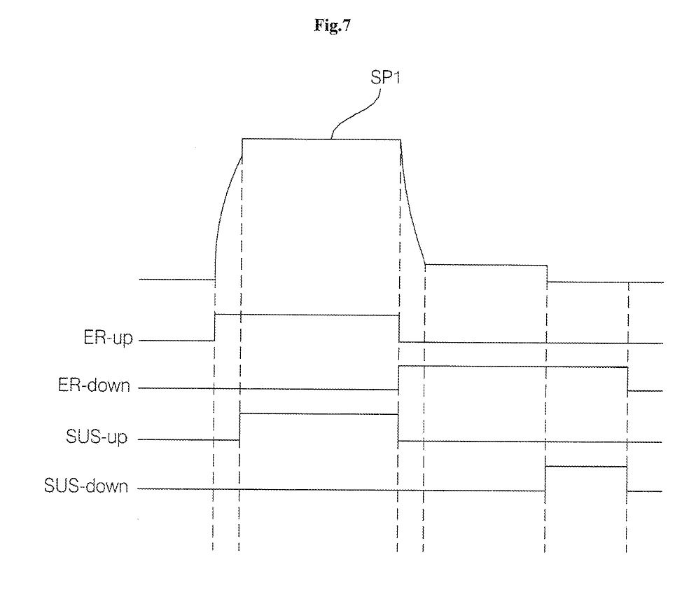

FIG. 6 illustrates a sustain pulse application circuit of the plasma display apparatus according to the present invention, and FIG. 7 is a timing diagram of a switch for applying the sustain pulse according to the present invention. In detail, FIG. 7 illustrates operation timing of the switch provided at the sustain pulse application circuit of FIG. 6 for generating the sustain pulse substantially identical with that of the second embodiment of the present invention.

As shown in FIG. 6, the circuit for applying the sustain pulse (SP1) includes the energy recovery unit (ER) for recovering and, upon generation of the sustain pulse, reusing reactive current of the plasma display apparatus, and a sustain unit (\textcircled{s}) connected with the energy recovery unit and generating the high electric potential sustain voltage (Vs) or the low electric potential sustain voltage (Vo) of the sustain pulse.

The energy recovery unit (ER) includes a source capacitor (Cs) for storing recovered energy, an inductor (L) for forming resonance circuit and forming resonance current, and at least one switch (ER-up, ER-down) connected in parallel between the source capacitor and the inductor and controlling energy supply/recovery.

The sustain unit (\textcircled{s}) includes a plurality of switches (SUS-up, SUS-down) connected in parallel between the scan electrode (Y) or sustain electrode (Z) and the inductor (L).

As shown in FIG. 7, if a control signal is applied to a first recovery switch (ER-up) provided at the energy recovery unit (ER) and turns on the energy recovery unit (ER), the charges stored in the source capacitor (Cs) are supplied to the scan electrode or the sustain electrode (Z). The resonance circuit is formed by the inductor and therefore, a double voltage of voltage stored in the source capacitor (Cs) is applied to the scan electrode or the sustain electrode.

If the first recovery switch (ER-up) turns on and the first sustain switch (SUS-up) turns on, the high electric potential sustain voltage (Vs) is applied to the scan electrode (Y) or the sustain electrode (Z). As the first sustain switch turns on, the scan electrode or the sustain electrode sustains the high electric potential sustain voltage (Vs).

After lapse of a predetermined time, if the first recovery switch (ER-up) and the first sustain switch (SUS-up) turn off and the second recovery switch (ER-down) turns on, a current path from the inductor (L) and the second recovery switch (ER-down) to the source capacitor (Cs) is formed.

Accordingly, the energy stored in the plasma display apparatus is recovered to the source capacitor (Cs), and the second recovery switch (ER-down) is electrically conducted and the resonance circuit is formed. If so, the voltage of the scan electrode (Y) or the sustain electrode (Z) is reduced to the first sustain voltage (V-erase).

As such, if the second recovery switch (ER-down) is conducted and sustained for a predetermined time, the scan electrode (Y) and the sustain electrode (Z) sustain the first sustain voltage (Vs₁).

After the first sustain voltage (Vs₁) is sustained for a predetermined time, if the second sustain switch (SUS-down) turns on, the scan electrode (Y) or the sustain electrode (Z) has the low electric potential sustain voltage (Vo).

As described above, in the inventive plasma display apparatus, the total falling time of the last sustain pulse applied to the scan electrode and sustain electrode is sustained long and, in the duration for reducing from the high electric potential sustain voltage to the low electric potential sustain voltage, a predetermined voltage is sustained for a predetermined time or is reduced with slopes of several steps, to erase the wall charges excessively formed within the discharge cell, thereby stabilizing the subsequent erasure and reset discharges and accordingly, providing effect of preventing the erroneous discharge and the luminescent spot.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a first electrode formed at an upper substrate; and
a driver for applying a sustain pulse to the first electrode,
wherein the driver applies a driving waveform whose, in one subfield, any one sustain pulse (SP1) has a longer falling time than another sustain pulse (SP2) applied earlier than the sustain pulse (SP1).

2. The apparatus of claim 1, wherein the first electrode is a scan electrode or a sustain electrode.

3. The apparatus of claim 1, wherein the sustain pulse (SP1) is a sustain pulse applied in the last of a sustain period.

4. The apparatus of claim 1, wherein the sustain pulse (SP2) applied earlier than the sustain pulse (SP1) has a falling time of about 480 ns to 600 ns.

5. The apparatus of claim 1, wherein the sustain pulse (SP1) has a falling time of about 1 μs to 2 μs.

6. The apparatus of claim 1, wherein the sustain pulse (SP1) has a falling time of about 1.5 μs to 2 μs.

7. A plasma display apparatus comprising:
a first electrode formed at an upper substrate; and
a driver for applying a sustain pulse to the first electrode,
wherein the driver applies a driving waveform whose, in one subfield, any one sustain pulse (SP1) comprises duration for falling from high electric potential voltage to first voltage, duration for substantially sustaining the first voltage for a predetermined time, and duration for falling from the first voltage to low electric potential voltage, and its total falling time is longer than a falling time of another sustain pulse (SP2) applied earlier than the sustain pulse (SP1).

8. The apparatus of claim 7, wherein the first electrode is a scan electrode or a sustain electrode.

9. The apparatus of claim 7, wherein the sustain pulse (SP1) is a sustain pulse applied in the last of a sustain period.

10. The apparatus of claim 7, wherein the first voltage has a sustain time of about 500 ns to 1 μs.

11. The apparatus of claim 7, wherein the sustain pulse (SP2) applied earlier than the sustain pulse (SP1) has a falling time of about 480 ns to 600 ns.

12. The apparatus of claim 7, wherein, in the sustain pulse (SP1), the total falling time from the high electric potential voltage to the low electric potential voltage is about 1.5 μs to 2 μs.

13. A plasma display apparatus comprising:
a first electrode formed at an upper substrate; and
a driver for applying a sustain pulse to the first electrode,
wherein the driver applies a driving waveform whose, in one subfield, upon fall, any one sustain pulse (SP1) falls along slopes having at least two steps, and its total falling time is longer than a falling time of another sustain pulse (SP2) applied earlier than the sustain pulse (SP1).

14. The apparatus of claim 13, wherein the first electrode is a scan electrode or a sustain electrode.

15. The apparatus of claim 13, wherein the sustain pulse (SP1) is a sustain pulse applied in the last of a sustain period.

16. The apparatus of claim 13, wherein the driver applies the driving waveform with the slopes of the respective steps different from each other.

17. The apparatus of claim 13, wherein the driver applies a driving waveform falling along slopes having three steps whose second step has a falling time of about 500 ns to 1 μs.

18. The apparatus of claim 17, wherein, in the driving waveform, the slope of the second step is most gentle.

19. The apparatus of claim 13, wherein the sustain pulse (SP2) applied earlier than the sustain pulse (SP1) has a falling time of about 480 ns to 600 ns.

20. The apparatus of claim 13, wherein the total falling time of the sustain pulse (SP1) is about 1.5 μs to 2 μs.
